(19) United States
(12) Patent Application Publication
(10) Pub. No.: US 2005/0239478 A1
(43) Pub. Date: Oct. 27, 2005

(54) Terminal location

(75) Inventor: Maurizio Spirito, Torino (IT)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation, FIN-02150 Espoo (FI)

(21) Appl. No.: 10/528,763

(22) PCT Filed: Sep. 3, 2003
(86) PCT No.: PCT/IB03/04331

§ 371 Date: May 19, 2005

(51) Int. Cl. H04Q 7/20

(52) U.S. Cl. 455/456.1

(57) ABSTRACT

A method for locating a mobile terminal in a communications network, the method comprising the steps of: applying one of a plurality of available methods to estimate a location of the mobile terminal; and applying one of a plurality of available methods to calculate a region around the estimated location in which the mobile terminal could be located.

The present invention relates to a method and an apparatus for locating a mobile terminal in a communications network, particularly but not exclusively using multiple sources of information.

The ability to pinpoint the location of mobile terminals is a desirable feature of a mobile telephone network. This is because of the need to provide customer services which rely on knowing the whereabouts of users of these services. For example, up-to-date local traffic information can be provided to enable a user to avoid nearby traffic jams. A user may also wish to know, for example, how to get to the nearest pub or restaurant from their present location. Clearly the location of the user must be ascertained to within even a few metres for this type of service to work.

Another reason for wishing to know the location of a mobile terminal is so that emergency services can locate a caller who is unable to provide an accurate personal location themselves.

It is known in a GSM mobile network to provide the location of a mobile telephone in terms of the cell of the network in which the telephone is located. Each cell contains one base station and a telephone is only ever in traffic communication with one base station at a given time. Hence the location of the telephone to an accuracy of the cell area can be determined simply by ascertaining with which base station the telephone is communicating. Such methods are known as cell-based location methods. Other methods can be combined with the cell identity, such as a triangulation system, in which the location of a particular mobile phone is calculated using control signals from at least the three base stations closest to it (two of which are located in adjacent cells to the cell in which the mobile telephone is located). This system uses the assumption that the distance of the phone from a base station is proportional to the strength of the signal which the base station receives from it, or the time taken for the signal to travel between the phone and the respective base station. Thus the position of the phone can be determined by comparing the relative strengths or travel times of received signals between the three base stations and thus assessing the distance of the user from each base station. The actual location of the user is then obtainable geometrically since the location of the base stations is known and fixed.

In a 3GPP (3^{rd} Generation Partnership Project) network using a Wideband Code Division Multiple Access (W-CDMA) signalling system, it is possible for a mobile terminal to be in active communication with more than one base station at any one time. This situation is known as “soft handover” and differs from (hard) handover in a GSM system, in which a mobile terminal is “handed over” from one base station to another as it moves between cells of the network. Because of the nature of the soft handover, the above-described cell-based mobile location procedures suitable for GSM can not always be used in a W-CDMA type signalling system. It would be desirable to provide a more reliable way of locating a mobile terminal in this type of signalling system.

In W-CDMA a “softer handover” is defined as well. In the case of “softer handover” the antennas of the base stations with which the mobile station is communicating are co-located (e.g. they are installed at the same physical location). In the remainder of this document, the term “soft handover” will be used also to cover the case of “softer handover”, and it will be understood by those skilled in the art that the invention and the described embodiments thereof are applicable to a softer handover situation as well as a soft handover situation.

A problem associated with providing the location of a mobile terminal is that in order for the provided location to be meaningful and usable, the accuracy of the location provided must also be known. This is because it would be pointless, for example, to advise a user of the nearest restaurant to the location provided if the user's actual position could be within a range of several km. The accuracy can depend on a number of factors such as the type of base station antenna (e.g. omni-direction or directional), the cell size (i.e., the extension of the geographical region served by the base station) and the density of network coverage (number of base stations per square km) in the area in which the mobile terminal is located. It would also be desirable to know the accuracy of the location of a mobile terminal provided.

According to the present invention there is provided a method as set out in claim 1.

Further preferred aspects of the invention are set out in the other claims.

Embodiments of the invention will now be described, by way of example only, with reference to the accompanying drawings in which:

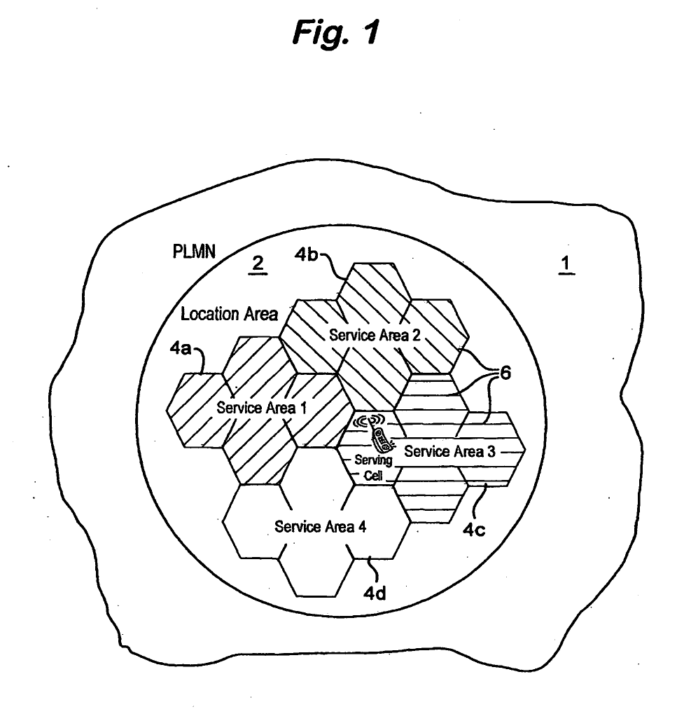

FIG. 1 shows schematically a mobile network divided into service areas

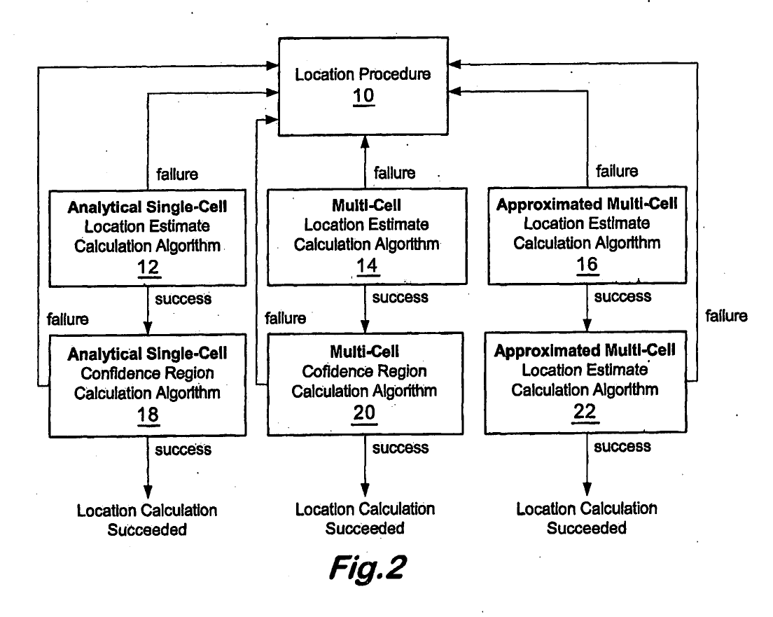

FIG. 2 shows a flow chart for a mobile terminal location procedure in accordance with embodiments of the invention

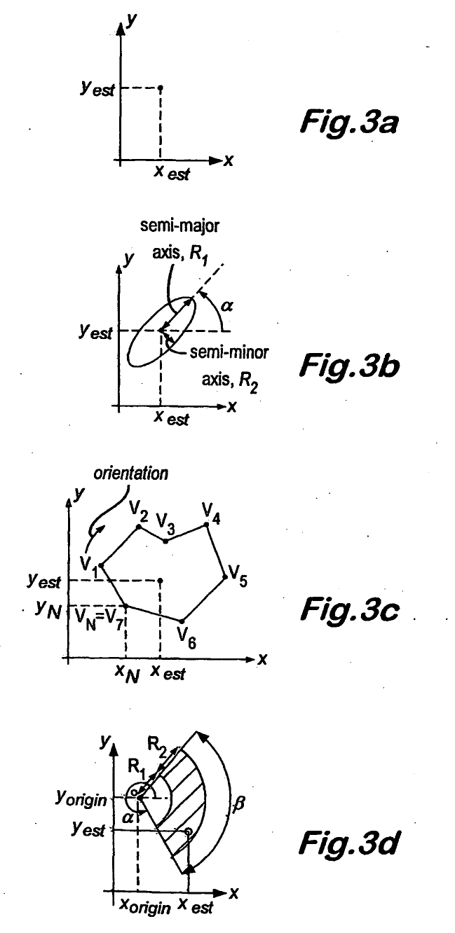

FIG. 3 shows diagrams representing various possible confidence calculation methods

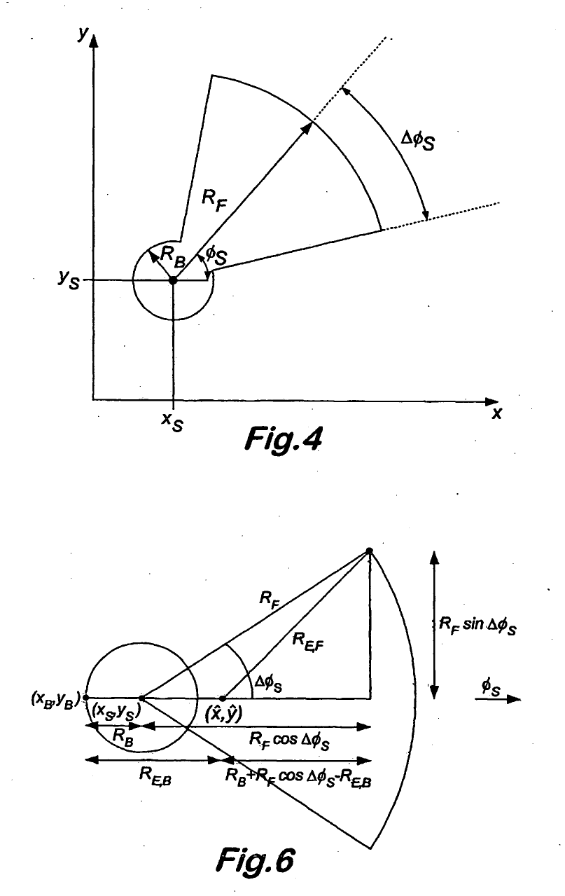

FIG. 4 shows the modelling of a cell of the network

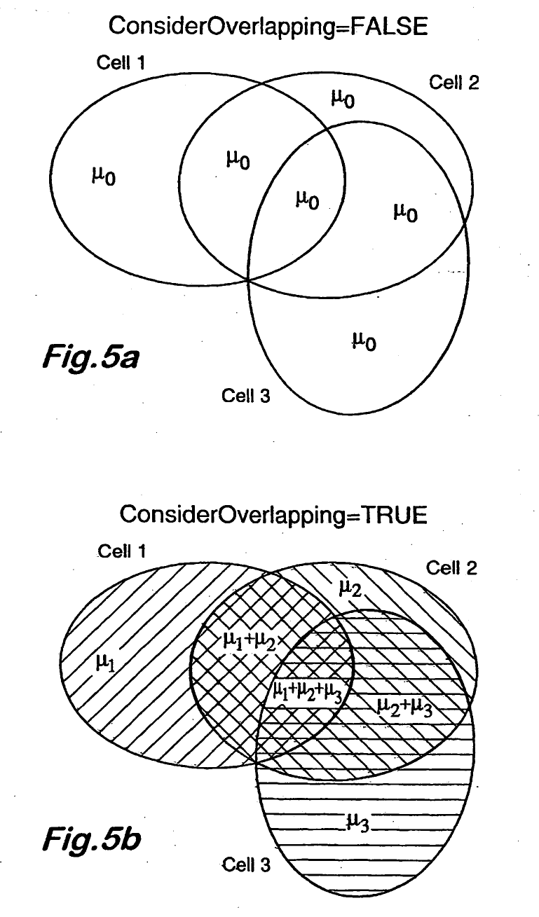

FIG. 5 shows two different approaches to evaluation of service area density

FIG. 6 shows geometry for deriving a circular confidence region and a circular arc confidence region according to one embodiment of the invention

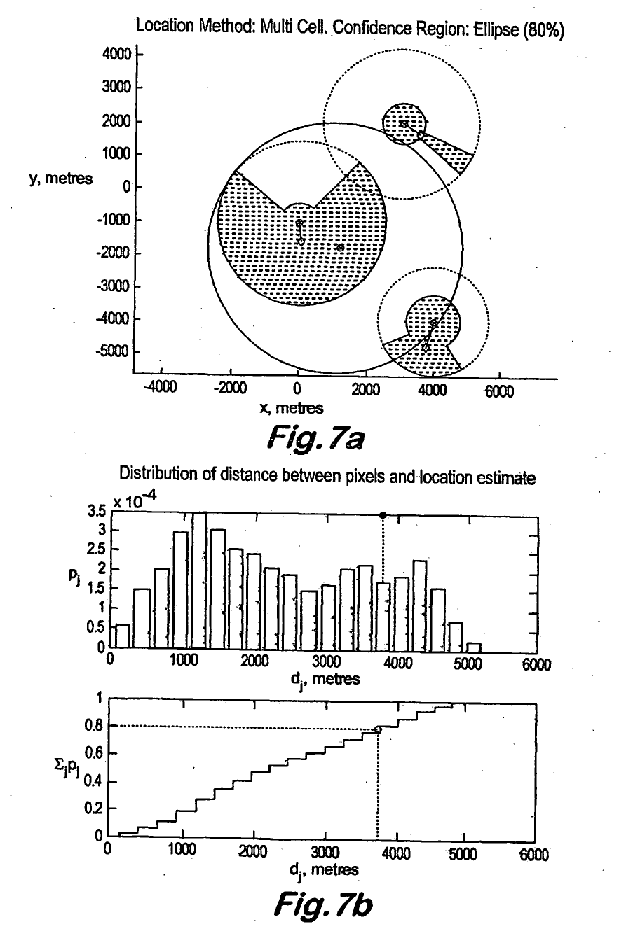

FIG. 7 shows a circular confidence region calculation according to a second embodiment of the invention.

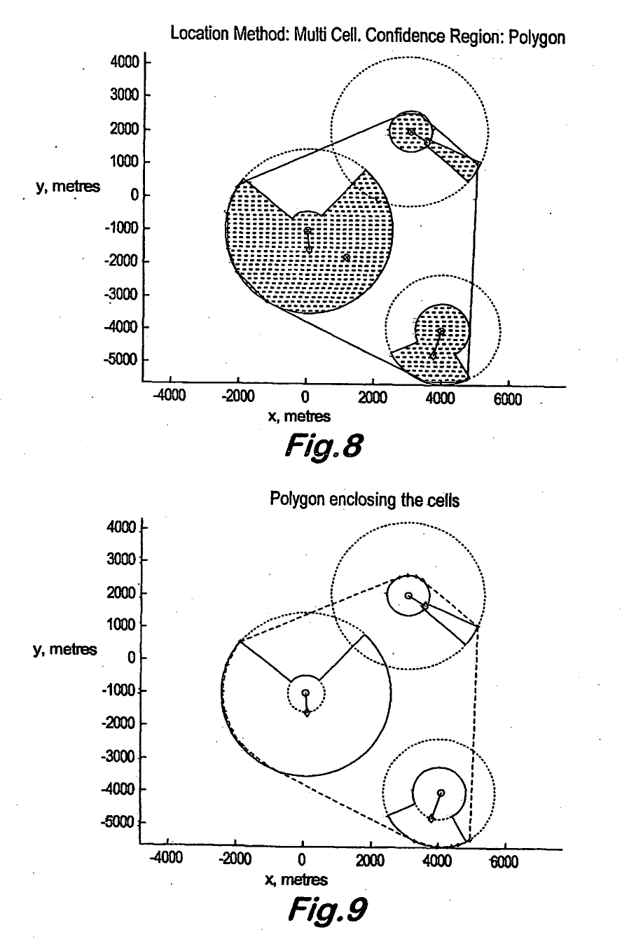

FIG. 8 shows a polygonal confidence region generated according to a variation on the second embodiment of the invention.

FIG. 9 shows how the location of a mobile terminal is obtained in accordance with a third embodiment of the invention

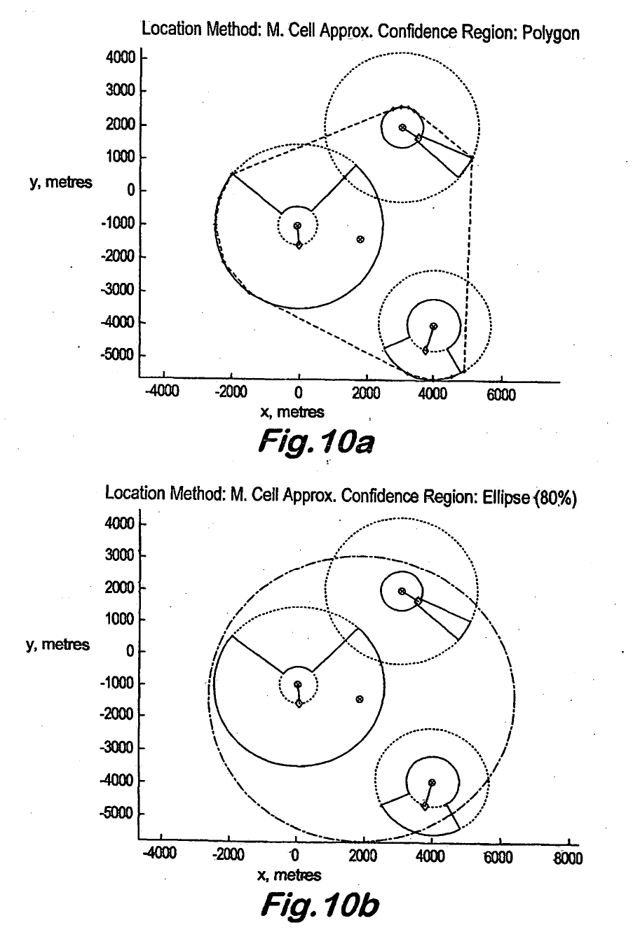

FIG. 10 shows an elliptical and a polygonal confidence region according to variations on the third embodiment of the invention

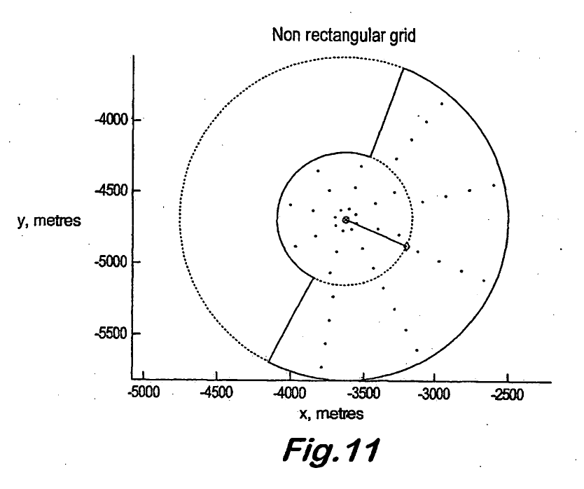

FIG. 11 shows a grid for use in another variation on the third embodiment of the invention.

FIG. 1 shows schematically part of a Universal Mobile Telephone System (UMTS) Public Land Mobile Network (PLMN). The PLMN is indicated by reference numeral 1 and it will be appreciated that the network 1 extends well beyond the boundary drawn in the figure. Within the network 1 is shown a location area (LA) 2. The LA 2 is depicted as being circular but this is not necessarily the case in practice. There are in fact a number of location areas within the network 1 but the others are not shown. The location area 2 comprises a number of service areas 4, in this example four (4a-4d) as shown in FIG. 1 distinguished by different shading. Thus a Service Area (SA) is defined as a set of cells within a larger Location Area (LA). In the example of FIG. 1, each SA 4 comprises four cells 6, but an SA could comprise a different number of cells.

It can be seen that in FIG. 1 the cells 6 are hexagonal in shape and that consequently the shape of each SA 4 is that of four adjacent hexagons. This is a well-known approximation to the shape of real network cells.

The Service Area is identified with a parameter called Service Area Identifier (SAI). Thus the SAI can be used to identify one or more cells contained in the same Service Area. Each cell has a unique Cell Identity (CI) and has one base station via which mobile terminals can access the network 1. Any cell with which a mobile terminal has an active connection is termed a serving cell. A mobile terminal can have an active connection with more than one cell at any one time. This state is known as “soft handover”.

The embodiments of the invention which will be described below are directed towards calculation of a location estimate and a “confidence region” associated with the location estimate of a User Equipment (UE). The various embodiments cover the use of single and multiple Cell Identity (CI) information. The approaches of the embodiments are suitable for application in the context of at least the following two available UMTS location methods:
Service Area Identifier (SAI) location method
Cell Identity and Round Trip Time (CI+RTT) location method

The system has a plurality of methods available to it which it can apply to the determined location so as to estimate a confidence region in which the mobile station could be located to a set probability,

Before describing the embodiments, these two location methods will be explained.

Service Area Identifier (SAI) Location Method

In the context of the SAI location method, embodiments of the invention perform location calculations based on the fact that the UE is in a certain Service Area. This method is intended to calculate the location estimate and the confidence region associated with the location estimate of a User Equipment (UE) which is reported to be within a known SA of the UMTS PLMN of interest.

The SAI identifying the SA to which a certain cell belongs is defined by the combination of three codes/identifiers, as follows:
SAI=PLMN−Id+LAC+SAC
where:
PLMN-Id: PLMN Identifier, defined in turn by the combination of
   MCC: Mobile Country Code (common to all cells of the whole PLMN)
   MNC: Mobile Network Code (common to all cells of the whole PLMN)
LAC: Location Area Code
SAC: Service Area Code

Any given cell may belong to one or two Service Areas. When it belongs to two Service Areas, one is applicable in the broadcast (BC) domain and the other is applicable in both the CS (Circuit Switched) and PS (Packet Switched) domains of the network. A Service Area in the BC domain consists of only one cell, whereas such limitation does not apply in general to CS and PS domains.

The SAI defined in the CS and PS domains (and not the one defined in the BC domain) can be used to indicate the location of a UE to the Core Network (CN) for LCS (LoCation Services) purposes. In UMTS, this is done by the Serving Radio Network Controller (S-RNC) which, when requested, maps the Cell Identity (CI) of the serving cell into the SAI identifying the Service Area to which the serving cell belongs, and sends the SAI to the CN by means of the RANAP signalling over the Iu interface.

In general terms, the SAI location calculation algorithm can be used to estimate geographical coordinates and associated confidence region of a UE when the only location information available is the identity of cells in the Service Area of the serving cell (or cells, when the UE is in soft handover).

Cell Identity and Round Trip Time (CI+RTT) Location Method

In the context of a CI+RTT location method, embodiments of the invention perform location calculations based on the fact that when no RTT or RxTxTD measurements (which measurements are in principle available in CI+RTT location method, see below) are used or can be used, information from multiple serving cells can be combined to perform location calculations. This is possible in a W-CDMA type network due to the soft handover functionality mentioned above.

The CI+RTT location method in UMTS relies on the availability of Round Trip Time (RTT) and Rx−Tx Time Difference (RxTxTD) measurements. RTT and RxTxTD measurements are introduced in UMTS FDD (Frequency Division Duplex) to allow the implementation of the CI+RTT location method.

The RTT is defined as RTT=T_{Rx}^{UL}−T_{TX}^{DL}, where TD_{TX}^{DL} is the time of transmission of the beginning of a downlink dedicated physical channel (DPCH) frame to a User Equipment (UE) and T_{RX}^{UL} is the time of reception of the beginning (the first detected path, in time) of the corresponding uplink DPCCH (Dedicated Physical Control Channel)/DPDCH (Dedicated Physical Data Channel) frame from the UE.

The RTxTxTD=T_{Tx}^{UL}−T_{Rx}^{DL} is the difference in time between the UE uplink DPCCH/DPDCH frame transmission (T_{Tx}^{UL}) and the first detected path (in time) of the downlink DPCH frame from the measured radio link (T_{Rx}^{DL}).

RTTs are measured by the base stations, RxTxTDs are measured by the UE.

By combining a pair of RTT and RxTxTD measurements referred to the same base station the distance between the UE and that base station can be estimated. Such distance estimate is analogous to the distance estimate that can be obtained from one Timing Advance (TA) in GSM. In this sense, the CI+RTT location method corresponds to the Cell Identity+Timing Advance (CI+TA) location method in GSM. However, two particular features of UMTS FDD make the CI+RTT method potentially more accurate than the CI+TA method in GSM:
1. The much shorter UMTS chip period as compared to the GSM bit period affects the resolution with which a distance estimate can be determined from a TA in GSM or from an (RTT, RxTxTD) pair in UMTS. One GSM bit period is equivalent to approximately 1100 meters while one UMTS chip period is equivalent to approximately 80 meters, thus the distance measurements resolution in UMTS is better than in GSM.
2. In UMTS a UE can be in soft handover. UMTS standards require that RTTs and RxTxTDs are measured for each active radio link, thus multiple distance estimates can be potentially available for locating one UE in UMTS. In GSM this is not possible since the TA is available only for the unique serving cell.

In the CI+RTT location method the unknown geographical coordinates of the UE whose position it is desired to determine are estimated by combining absolute distance measurements between the UE and the base stations in the active set. Each absolute distance measurement is calculated from each (RTT, RxTxTD) pair.

In real applications it may happen that no (RTT, RxTxTD) pairs are available for location calculation. This may be due for instance to a measurement process failure or to a UE not supporting RxTxTD measurements. In such circumstances the CI+RTT location method can still perform successfully a location calculation only on the basis of the knowledge of the CI of the serving cell for of the multiple serving cells if the UE is in soft handover).

Even when all (or some) of the (RTT, RxTxTD) pairs are available, the location calculation based on the serving cell(s) identity can be used to improve performance of location algorithms that make use of RTT and RxTxTD measurements.

Thus the CI+RTT location method can use similar algorithms as the ones used by the SAI location method to estimate geographical coordinates and associated confidence region of a UE when the only location information available is the identity of the serving cells.

Having explained two location methods within which the invention can operate, embodiments of the invention will now be described, firstly with reference to FIG. 2. As mentioned previously, the embodiments of the invention involve the two main steps of:
1. estimating the location of the UE in terms of x-y coordinates and
2. calculating a confidence region for this location estimate.

A confidence region is a geographical region where the exact UE location is estimated to be with a given probability, referred to as the confidence coefficient 0<ξ≦1.

Embodiments of the invention are implemented using the following location calculation methods (step 1):
a) Analytical Single-Cell Location Method
b) Multi-Cell Location Method
c) Approximated Multi-Cell Location Method

These location calculation methods are implemented by location calculation algorithms. Two classes of location calculation algorithms are used:
Location Estimate Calculation Algorithms to implement step 1
Confidence Region-Calculation Algorithms to implement step 2

FIG. 2 is a flow chart showing the logical structure of embodiments of the invention. At the top of FIG. 2 is a high level location procedure 10 which controls all operations. The location procedure 10 calls lower level Location Estimate Calculation Algorithms (LECAs) (step 1) and Confidence Region Calculation Algorithms (CRCAs) (step 2). LECAs calculate a location estimate by implementing one of the three available location methods a) to c) described below as three embodiments of the invention.

FIG. 2 shows that location estimate and confidence region calculation algorithms are kept logically separated. Thus below the location procedure 10 are shown three location estimate procedures, an “Analytical SingleCell” procedure 12, a “Multi-Cell” procedure 14 and an “Approximated Multi-Cell” procedure 16. Below the three location estimate procedures 12, 14, 16 are shown three confidence region procedures 18, 20, 22, corresponding respectively to the three location estimate procedures. An arrow from each location estimate procedure to its respective confidence region procedure shows that a confidence region is calculated only after a location estimate is calculated successfully. The possible ways of calculating a confidence region will be described below.

When it is desired to obtain the location of a UE in the network 1, the location procedure 10 calls one of the three location estimate procedures 12, 14, 16. The choice of location procedure is influenced by a user-defined variable “PreferredLocationMethod”. This variable indicates a preference towards a Location Calculation Method that should be used first for calculation of the location of the UE. The variable is set according to the type of base stations in the SA and the concentration of them, with the aim of using the type of calculation that is most likely to succeed first. If the chosen location calculation method fails for any reason, as shown in FIG. 2, control reverts to the location procedure 10, which decides whether to call a new LECA or to terminate the procedure with a failure. The location calculation could fail for a number of reasons, for example because for certain SA configurations the calculation according to a specific LECA might require an amount of resources (memory, computational capacity, etc.) that, at that specific moment, are not available in the system where the LECA is implemented.

When a LECA succeeds the CRCA calculating the confidence region according to the same Location Method implemented by the LECA that succeeded last is called. If the CRCA also succeeds the location procedure terminates successfully. On the other hand, if the CRCA fails, as shown in FIG. 2, control returns to the location procedure 10, which can then decide whether to try a different CRCA.

The combination of location estimate and confidence region parameters is referred to as “shape”. The shape definitions supported by the location calculation algorithms described above are:
(i) Point Shape (i.e. including only the location estimate)
(ii) Point with Uncertainty Ellipse Shape (where the confidence region is an ellipse)
(iii) Point with Uncertainty Polygon Shape (where the confidence region is a polygon)
(iv) Point with Uncertainty Arc Shape (where the confidence region is a circular arc)

Diagrammatic representations of these four shape types are shown in FIGS. 3a-3d. In the figures (xₑₛₜ,yₑₛₜ) corresponds to (\hat{x},ŷ) and x_{origin}, y_{origin} corresponds to x₀,y₀.

FIG. 3a shows the point shape. This has only one feature:
Coordinates of the location estimate x and y

FIG. 3b shows the point with uncertainty ellipse shape. This has the following features:
Coordinates of an origin (at the location estimate) (\hat{x},ŷ)
Semi-major axis R1 and semi-minor axis R2
Orientation angle α
Confidence coefficient value ξ

FIG. 3c shows the point with uncertainty polygon shape. This has the following features:
Coordinates of a location estimate (\hat{x},ŷ).
Number of vertices N (in the figure N=7)
Coordinates of the vertices (x₁,y₁), . . . , (X_{N},X_{N})

FIG. 3d shows the Point with Uncertainty Arc Shape. This has the following features:
Coordinates of a location estimate (\hat{x},ŷ)
Coordinates of an origin xₒ and yₒ
Inner radius R1 and uncertainty radius R2
Offset (orientation) angle α and included angle β
Confidence coefficient value ξ

The CRCA used to determine the confidence region depends both on the location method used to determine the location estimate and on the shape type used to represent the results. The shape type is influenced by a user-defined variable: “PreferredShapeType”. This variable indicates a preference towards a shape type that should be used to represent the results. This variable can be set appropriately to best show the confidence region in dependence on the characteristics of the SA.

Finally, the choice of LECA and CRCA is influenced by a third user-defined variable “MethodsAndShapesAllowed”. This variable defines a list of location method and shape type combinations that the location procedure is allowed to use. Certain combinations may be incompatible, as some of the examples below will explain.

A logical description of the location procedure is indicated in the following:

Stage 1: Create the List of Location Estimate Calculation Algorithms LECAList

The list LECAList includes the Location Estimate Calculation Algorithms (LECAs) to be tried to determine a location estimate. The list is created by taking into account the following constraints:
1. Give highest priority to the LECA implementing the PreferredLocation Method or, if only one cell must be considered, to those implementing the “Analytical Single-Cell” method.
2. Add to the list only the LECAs implementing Location Methods that are allowed (i.e., those appearing at least once in the list MethodsAndShapesAllowed)

Loop 1: Loop over the list LECAList, trying only once each LECA in the list.

As soon as one LECA in the list LECAList succeeds in determining a location estimate, go to Stage 2. If none of the LECAs in the list LECAList succeeds in determining a location estimate or if all LECAs in the list LECAList have already been tried, go to Stage 4.

Stage 2: Create the List of Confidence Region Calculation Algorithms CRCAList

The list CRCAList includes the Confidence Region Calculation Algorithms (CRCAs) to be tried to determine a confidence region. The list is created by taking into account the following constraints:
1. Give highest priority to the CRCA that determines a confidence region with the shape specified by PreferredShapeType.
2. Add to the list only the CRCAs that are allowed (i.e., those delivering a confidence region that, according to the list MethodsAndShapesAllowed, the Location Procedure is allowed to use when the LECA is the one that succeeded during Loop 1)

Loop 2: Loop over the list CRCAList, trying only once each CRCA in the list.

As soon as one of the CRCA in the list LECAList succeeds in determining the confidence region go to Stage 3.

If none of the CRCAs in the list CRCAList succeeds, return to Loop 1 and try the next LECA in the list LECAList.

Stage 3: Location Procedure Terminated with a Success

The location result is represented in the shape type obtained by combining the latest location estimate determined inside Loop 1 and the corresponding confidence region determined inside Loop 2.

Stage 4: Location Procedure Terminated with a Failure

A failure occurred because all LECAs in the list LECAList were tried and either none of them succeeded, or although some (or all) of them succeeded, none of the corresponding CRCAs in the list CRCAList succeeded in determining a confidence region.

Having explained the logical process steps involved in embodiments of the invention, the LECAs and the CRCAs will now be described.

LECAs

The first consideration is modelling the geographical extension of each network cell of interest. The model is created by means of the following radio network parameters:
x-y coordinates for the Base Transceiver Station (BTS) antenna, (xs,ys)
Bearing of the BTS antenna measured counterclockwise from x-axis in radians, φs
Half Power Beam Width (HPBW) of the BTS antenna measured in radians, Δφs
Maximum front radius of the cell, R_{F}. This parameter specifies the maximum radius of the geographical region illuminated by the main radiation lobe of the BTS antenna, where the cell is serving.
Maximum back radius of the cell, R_{B}. This parameter specifies the maximum radius of the geographical region illuminated by the back radiation lobe of the BTS antenna, where the cell is serving.

FIG. 4 shows a representation of the cell border in the x-y plane. Based on the five radio network parameters listed above, each cell of interest is mathematically modeled in the (x,y) plane as follows:

$$C ( x , y ) : \{ \begin{matrix}d ( x , y ) = {R}_{F} ; & 0 \leq \vert ψ ( x , y ) - {ϕ}_{S} \vert \leq Δ {ϕ}_{S} \\ d ( x , y ) = {R}_{B} ; & \vert ψ ( x , y ) - {ϕ}_{S} \vert > Δ {ϕ}_{S}\end{matrix} \qquad ( 1 )$$

where d(χ,y)={square root over ((χₛ−χ)²+(yₛ−y²)} d(x,y) and ψ(χ,y) is such that tan

$$ψ ( x , y ) = \frac{{y}_{S} - y}{{χ}_{S} - χ}$$

(d and ψ so defined are the radial and angular coordinates of a polar reference system centered at the BTS site).

The border of the region covered by the N_{Cells} cells, S, is finally modeled by the algorithms as the union of N_{Cells} cell borders {C₁ . . . . C_{Ncells},} each of them modeled as in equation (1):

$$S = {{⋃}^{{N}_{Cells}}}_{( xx )} \cdot {C}_{t} \qquad ( 2 )$$

The principles of the LECAs will now be discussed. The algorithms calculate the location estimate coordinates at the mass center of the geographical area covered by the N_{Cells} cells of interest. According to this principle, the location estimate coordinates (\hat{χ},ŷ) are calculated using the following definitions:

$$\begin{matrix}\hat{x} = \frac{\int {\int }_{S}^{} μ ( x , y ) x ⅆ x ⅆ y}{\int {\int }_{S}^{} μ ( x , y ) ⅆ x ⅆ y} ; & \hat{y} = \frac{\int {\int }_{S}^{} μ ( x , y ) y ⅆ x ⅆ y}{\int {\int }_{S}^{} μ ( x , y ) ⅆ x ⅆ y}\end{matrix} \qquad ( 3 )$$

where S is the border of the geographical region covered by the N_{Cells} cells of interest and μ(x,y) is the density of the geographical region enclosed by S. By density is meant the density of users, measured in units such as number of users per square km.

In the context of the SAI location method S represents the Service Area (SA) border and μ(x,y) the Service Area density. In embodiments of the invention, two alternatives for μ(x,y) are available, according to the value of an algorithm parameter “ConsiderOverlapping”. This parameter can be set to TRUE or FALSE. The two alternatives are described in the following and exemplified in FIG. 5.

Alternative 1: ConsiderOverlapping=FALSE

The first alternative is to assume a uniform density over the whole SA. In this case (FIG. 5a), μ(x,y) is defined as follows:

$$μ ( x , y ) = \{ \begin{matrix}{μ}_{0} & ( x , y ) ∈ S \\ 0 & elsewhere\end{matrix} \qquad ( 4 )$$

where μ₀ is the constant density. Under this assumption the location estimate coordinates are expressed as

$$\begin{matrix}\hat{x} = \frac{1}{M ( S )} \int {\int }_{S}^{} x ⅆ x ⅆ y ; & \hat{y} = \frac{1}{M ( S )} \int {\int }_{S}^{} y ⅆ x ⅆ y\end{matrix} \qquad ( 5 )$$

where M(S)=∫∫ₛdxdy is the area of the region confined by the Service Area border S.
Alternative 2: ConsiderOverlapping=TRUE

According to the second alternative, when ConsiderOverlapping=TRUE, μ(x,y) is set to a value proportional to the number of cells covering the location of coordinates (x,y). In this case (FIG. 5b) the density is equal to the sum of N_{Cells} uniform densities of the cells in the Service Area:

$$μ ( x , y ) = {\sum }_{i = 1}^{{N}_{Cells}} {μ}_{i} ( x , y ) \qquad ( 6 )$$

where the density of the i-th cell μᵢ(x,y) is equal to the constant μᵢₒ over the cell area:

$${μ}_{i} ( x , y ) = \{ \begin{matrix}{μ}_{i0} & ( x , y ) ∈ {C}_{i} \\ 0 & elsewhere\end{matrix} \qquad ( 7 )$$

Under this assumption the UE location estimate (equation (3)) results as follows:

$$\begin{matrix}\hat{x} = \frac{{\sum }_{i = 1}^{{N}_{Cells}} {μ}_{i0} \int {\int }_{{C}_{i}}^{} x ⅆ x ⅆ y}{{\sum }_{i = 1}^{{N}_{Cells}} {μ}_{i0} M ( {C}_{i} )} ; & \hat{y} = \frac{{\sum }_{i = 1}^{{N}_{Cells}} {μ}_{i0} \int {\int }_{{C}_{i}}^{} y ⅆ x ⅆ y}{{\sum }_{i = 1}^{{N}_{Cells}} {μ}_{i0} M ( {C}_{i} )}\end{matrix} \qquad ( 8 )$$

where, M(Cᵢ)=∫∫_{c}_{ᵢ}μ(x,y)dxdy is the area of the i-th cell.

From the comparison of this result with equation (5) it is evident that the location estimate (equation (8)) is the weighted average of the Ncells mass centers of the cells of interest; where the weight of the i-th mass center is

$$\frac{{μ}_{i0} M ( {C}_{i} )}{{\sum }_{i = 1}^{{N}_{Cells}} {μ}_{i0} M ( {C}_{i} )} \qquad ( i = 1 , … , {N}_{Cells} ) .$$

It should be remarked here that in examples described below, μ₀ and μ₁₀ are both set to 1 to simplify the calculations for illustrative purposes.

Confidence Region Calculation

As explained previously, the location estimate coordinates and the confidence region parameters resulting from the calculation performed by a location calculation algorithm are combined and represented with any of the four shape formats represented in FIG. 3.

In practice all location methods except method a) “Analytical Single-Cell” return a confidence region with the shape of a circle when they are requested to provide either a “Point with Uncertainty Arc” or a “Point with Uncertainty Ellipse” shape type. The circle is centered at the location estimate coordinates and has a radius R_{CR}, in general dependent on the confidence coefficient 0<ξ≦1. For this reason, in the following examples no difference is made, unless explicitly stated, between Arc and Ellipse confidence region calculations in the case of “Multi-Cell” and “Approximated Multi-Cell” location methods.

It can further be understood that a circular confidence region Is represented using the “Point with Uncertainty Arc” shape format by setting the inner radius R₁ to zero, the uncertainty radius R₂ to R_{CR} and the included angle β to 2π (the offset angle α is meaningless). See FIG. 3 for a graphical representation of these variables. The same circular confidence region is represented using the “Point with Uncertainty Ellipse” shape format by setting both the semi-major axis R₁ and the semi-minor axis R₂ to the radius R_{CR} (the orientation angle α is meaningless). See FIG. 4 for a graphical representation of these variables.

### EXAMPLES

### First Embodiment

### Analytical Single-Cell Algorithms

The “Analytical Single-Cell” location method can be applied when only one cell is to be considered. In the following the algorithms implementing the location estimate and confidence region calculation are presented.

Step 1: Location Estimate Calculation

The location estimate is calculated at the mass center of the unique cell of interest (N_{Cells}=1). The coordinates of the mass center of the cell can be calculated by evaluating analytically the integrals in equation (3). It can be shown that by assuming a uniform density the following expression for the location estimate results:

$$\{ \begin{matrix}\hat{x} = {x}_{S} + \frac{2}{3} \frac{( {R}_{F}^{3} - {R}_{B}^{3} ) sin Δ {ϕ}_{S}}{{R}_{F}^{2} Δ {ϕ}_{S} + ( π - Δ {ϕ}_{S} ) {R}_{B}^{2}} cos {ϕ}_{S} \\ \hat{y} = {y}_{S} + \frac{2}{3} \frac{( {R}_{F}^{3} - {R}_{B}^{3} ) sin Δ {ϕ}_{S}}{{R}_{F}^{2} Δ {ϕ}_{S} + ( π - Δ {ϕ}_{S} ) {R}_{B}^{2}} sin {ϕ}_{S}\end{matrix} \qquad ( 9 )$$

Step 2: Confidence Region Calculation
First Variation: Ellipse

The elliptical confidence region has the shape of a circle, the radius of which, R_{CR}, is calculated by scaling the distance between the location estimate and the furthest point on the cell borders (R_{MAX}) by a factor equal to the square root of the confidence coefficient 0<ξ≦1:
R_{CR}=\sqrt{ξ}R_{MAX} (10)

In this way the area of the circular confidence region having its centre at the location estimate and a radius equal to R_{CR} has a total area equal to a fraction ξ of the circle centered at the same point enclosing the whole cell (i.e., corresponding to ξ=1).

The maximum distance between the location estimate and the cell borders is defined as follows:
R_{MAX}=max{R_{E,B},R_{E,F}} (11)
where R_{E,B} is the distance between the location estimate and the furthest point on the back cell region, and R_{E,F} is the distance between the location estimate and furthest point on the front cell region. These two distances can be calculated geometrically, as represented in FIG. 6. R_{E,B} is defined as
R_{E,B}={square root over ((\hat{χ})}−χ_{B})²+(ŷ−y_{B})² (12)
where

$$\{ \begin{matrix}{x}_{B} = {x}_{S} - {R}_{B} cos {ϕ}_{S} \\ {y}_{B} = {y}_{S} - {R}_{B} sin {ϕ}_{S}\end{matrix} \qquad ( 13 )$$

R_{E,F} is defined as
R_{E,F}=\sqrt{(R_{F} sin Δφₛ)²+(R_{B}+R_{F} cos Δφₛ−R_{E,B})²} (14)
Second Variation: Arc

The parameters of an Arc shaped confidence region can be calculated by means of trigonometric formulas.

Third Variation: Polygon

Given the maximum number of confidence region vertices, N, the polygonal confidence region is simply determined by generating N equally spaced pixels along the perimeter of the cell. The pixels correspond to the confidence region vertices. Since the polygonal confidence region has no confidence coefficient associated with it (see shape type definitions described with reference to FIG. 3) there is no need to take into account the confidence coefficient in this calculation.

### Second Embodiment

### Multi-Cell Algorithms

In the multi-cell location method a location estimate is determined numerically at the mass center of a uniform rectangular grid covering the geographical region enclosed by the multiple cell borders. The method can be applied when one or more cells is to be considered.

The rectangular grid, which is used also to determine the confidence region, is obtained by sampling uniformly in the x and y directions the area covered by the cells of interest, using constant step sizes Δx and Δy, respectively. An example of a grid created is shown in FIG. 7a, and is defined by Np sets of three values:

$${\{ {x}_{p} , {y}_{p} , {w}_{p} \}}_{p = 1}^{{N}_{p}} \qquad ( 15 )$$

where
(xₚ,yₚ) are the central x-y coordinates of the p-th rectangular pixel having area Δχ*Δy;
wₚ is the number of cells that overlap in the area represented by the p-th pixel.
   Step 1: Location Estimate Calculation

The location estimate is determined through a discretised version of equation (3):

$$\hat{x} ≃ {\sum }_{p = 1}^{{N}_{p}} {q}_{p} {x}_{p} ; \hat{y} ≃ {\sum }_{p = 1}^{{N}_{p}} {q}_{p} {y}_{p} \qquad ( 16 )$$

where

$${q}_{p} = \frac{μ ( {x}_{p} , {y}_{p} )}{{\sum }_{l = 1}^{{N}_{p}} μ ( {x}_{l} , {y}_{l} )} ( p = 1 , … , {N}_{P} ) \qquad ( 17 )$$

is the normalised density associated with the path pixel, assumed constant over the pixel area.
Step 2: Confidence Region Calculation
First Variation: Circle

Given the location estimate coordinates (\hat{x},ŷ) the following set of distances between the location estimate and the grid pixels {xₚ,yₚ}ₚ₌₁^{N}^{ₚ} calculated:
\hat{χ}ₚ={square root over ((\hat{χ})}−χₚ)²+(ŷ−yₚ)² (p−1, . . . , N_{P}) (18)

The p-th distance is then weighted by the normalised density of the corresponding pixel, qₚ, and the resulting set of distances Np and corresponding weights is arranged in a discrete distribution defied by the following N_{D}≦Np sets of two values:

$${\{ {\hat{d}}_{j} , {p}_{j} \}}_{j = 1}^{{N}_{D}} \qquad ( 19 )$$

where \hat{d}₁<\hat{d}₂< . . . <\hat{d}_{N}_{_{D}} are the re-arranged ND distances and {pⱼ}_{jw1}^{N}^{_{d}} are the probabilities of the N_{D} distances such that Σ_{jw1}^{N}^{_{D}}pⱼ=1.

Subsequently, the radius of the circular confidence region R_{CR} is calculated as the (100ξ)-th percentile of the distance distribution (0<ξ≦1):

$${R}_{CR} = {\hat{d}}_{{j}_{0}} with {j}_{0} such that {\sum }_{j = 1}^{{j}_{0}} {p}_{j} = ξ \qquad ( 20 )$$

FIG. 7a shows the circular confidence region obtained using the algorithm described above on a three-cell sample using a confidence coefficient ξ=0.8. The same figure shows the pixel coordinates and location estimate as well. FIG. 7b shows the discrete distance distribution (equation (19)) and the corresponding 80-th percentile.

Second Variation: Polygon

Given the maximum number of confidence region vertices, N, the polygonal confidence region is obtained from the grid of Np pixels defined in equation (15) by properly selecting N outermost pixels that best approximate the grid borders. Since the polygonal confidence region has no confidence coefficient associated with it (see shape type definitions described with reference to FIG. 3) there is no need to take into account the confidence coefficient in this calculation.

FIG. 8 shows the polygonal confidence region resulting from the same sample cells used to produce the results shown in FIG. 7.

Effect of Service Area Density Assumption

In one implementation of the multi-cell location estimate calculation algorithms the density μ(xₚ,yₚ) used in equation (17) is defined according to the value of the parameter ConsiderOverlapping. When ConsiderOverlapping is FALSE the number of cells overlapping on each pixel area is not considered when calculating the location estimate, but when ConsiderOverlapping is TRUE, the overlapping is considered. These assumptions result in the following definition for μ(xₚ,yₚ):

$$μ ( {x}_{p} , {y}_{p} ) = \{ \begin{matrix}1 & ConsiderOverlapping = FALSE \\ {w}_{p} & ConsiderOverlapping = TRUE\end{matrix} \qquad ( 21 )$$

In the implementation when ConsiderOverlapping is TRUE the location estimate is not calculated with equation (16) but using explicitly equation (8), which is only approximated by equation 16).

### Third Embodiment

### Approximated Multi-Cell Algorithms

In this embodiment a location estimate is determined numerically at the mass centre of a polygon P enclosing the borders of the multiple cells. The method can be applied when one or more cells must be considered.

The polygon P is obtained as a polygon of Nᵥ vertices enclosing pixels equally spaced along the borders of the cells of interest. For location calculation purposes, the polygon P is used as an approximation of the border enclosed by the multiple cells (P approximates the border S defined in equation (1)). FIG. 9 shows an example of how a polygon enclosing three cells is obtained from pixels placed on the borders of the cells.

Step 1: Location Estimation Calculation

The location estimate coordinates (\hat{x},ŷ) are calculated at the mass center of the polygon P approximating the cells' border. Analytical formulas can be used for this purpose.

First Variation: Circle

The radius of the circular confidence region R_{CR} is calculated by scaling the distance R_{MAX} between the location estimate and the furthest vertex of the polygon P by a factor equal to the square root of the confidence coefficient 0<ξ≦1:
R_{CR}=\sqrt{ξ}R_{MAX} (22)

In this way the area of the circular confidence region having its centre at the location estimate and a radius equal to R_{CR} has a total area equal to a fraction ξ of the circle centered at the same point enclosing the whole polygon P used to approximate the border of the multiple cells (i.e., corresponding to ξ=1). FIG. 10a shows the circular confidence region resulting from the above calculation applied to the sample cells of FIG. 9 assuming ξ=0.8.

Second Variation: Polygon

Given the maximum number of the confidence region vertices, N, if N<Nᵥ the polygonal confidence region is obtained by properly selecting N vertices among the Nᵥ vertices of the polygon P. If N≧Nᵥ, the polygonal confidence region coincides with P itself. Since the polygonal confidence region has no confidence coefficient associated-(see shape type definitions as described with reference to FIG. 3) there is no need to take into account the confidence coefficient in this calculation. FIG. 10b shows a polygonal confidence region resulting from the sample cells of FIG. 9 (in the figure N=15).

Effect of Service Area Density Assumption

In one implementation of the third embodiment the polygon P is a convex polygon. The implementation can be effected with the parameter ConsiderOverlapping. If ConsiderOverlapping is set to FALSE the calculations of this Third embodiment as described above are performed. If, on the other hand, ConsiderOverlapping is set to TRUE the method is in practice the “Multi-Cell” location method (the second embodiment) with the difference that the grid (equation (15)) instead of being a uniform rectangular grid is a non rectangular grid obtained by subdividing each cell in the Service Area into Np circular arcs having approximately the same area, and by assigning:
the x-y coordinates of the p-th pixel (xₚ,yₚ) at the center of the p-th circular arc;
the weight wₚ equal to the area of the p-th circular arc.

An example of non rectangular grid created with this method and covering the area of one sample cell is represented in FIG. 11.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for locating a mobile terminal in a communications network, the method comprising the steps of:
estimating a location of the mobile terminal; and
applying one of a plurality of available methods to calculate a region around the estimated location in which the terminal could be located.

2. A method according to claim 1, wherein the step of estimating a location of the mobile terminal is performed using multiple sources of information.

3. A method according to claim 2, wherein the network comprises multiple cells and each source of information comes from a respective one of the multiple cells.

4. A method according to claim 2, wherein the mobile terminal is served by multiple cells of the network simultaneously and each source of information comes from a respective one of the multiple cells.

5. A method according to claim 1, wherein the step of estimating a location of the mobile terminal comprises the steps of selecting and applying a preferred method for estimating the location from a number of available methods.

6. A method according to claim 5, wherein if the selected method for estimating the location is unsuccessful when applied, the method comprises the further step of sequentially selecting and applying one or more others of the available methods until a selected method is successfully applied.

7. A method according to claim 5, wherein the available methods include: an algorithm using information from one cell of the network; an algorithm using information from multiple cells of the network; and a numerical method using information from multiple cells of the network.

8. A method according to claim 5, wherein the preferred method can be specified by setting a variable.

9. A method according to claim 1, wherein the step of calculating a region around the estimated location comprises the steps of selecting and applying a preferred method for calculating the region from the plurality of available methods.

10. A method according to claim 9, wherein if the selected method for calculating a region is unsuccessful when applied, the method comprises the further step of sequentially selecting and applying other of the available methods until a selected method is successfully applied.

11. A method according to claim 9, wherein the available methods for calculating the region include: an ellipse algorithm; a circle algorithm; an arc algorithm; and a polygon algorithm.

12. A method according to claim 9, wherein the methods include use of a parameter to calculate the region such that the probability of the mobile's exact location being in that region equals the parameter.

13. A method according to claim 9, wherein the step of estimating a location of the mobile terminal comprises the steps of selecting and applying a preferred method for estimating the location from a number of available methods, and wherein the selected method for estimating the location and the selected method for calculating the region together result in one of a number of shapes of region in which the mobile terminal could be located, the shape depending on the selected method for calculating the region.

14. A method according to any claim 9, wherein the step of estimating a location of the mobile terminal comprises the steps of selecting and applying a preferred method for estimating the location from a number of available methods, and wherein the method comprises the further step of applying a rule that specifies which of the possible methods for estimating the location can be used together with what available methods for calculating the region.

15. A method according to claim 1 wherein the step of estimating a location comprises the step of modelling a cell of the network.

16. A method according to claim 1, wherein the step of calculating a region around the estimated location in which the mobile terminal could be located comprises the step of modelling a cell of the network.

17. A method according to claim 1, wherein the network comprises a service area, the service area containing a number of cells including a cell in which the mobile terminal is located.

18. A method according to claim 17, wherein the service area is represented by the geographical region served by the cells in the service area.

19. A method according to claim 18, wherein the geographical region representing the service area is the region enclosed by a closed curve enclosing all borders of the geographical region served by the cells in the service area.

20. A method according to claim 18, wherein the step of estimating the location comprises a calculation of the mass centre of the geographical region representing the service area.

21. A method according to claim 18, wherein in the step of estimating a location, the network service density is assumed constant over the geographical region representing the service area.

22. A method according to claim 18, wherein the step of calculating a region around the estimated location in which the mobile terminal could be located assumes that the network service density is constant over the geographical region representing the service area.

23. A method according to claim 18, wherein in the step of estimating a location the network service density in the service area is assumed not constant over the geographical region representing the service area.

24. A method according to claim 18, wherein the step of calculating a region around the estimated location in which the mobile terminal could be located assumes that the network service density is not constant over the geographical region representing the service area.

25. A method according to claim 23, wherein the network service density in any given location of the geographical region representing the service area depends on the number of cells serving that given location.

26. A method according to claim 1, applied in a 3GPP telecommunications network.

27. A method according to claim 1, applied in a Service Area Identifier location method.

28. A method according to claim 1, applied in a Cell Identity and Round Trip Time location method.

29. A location module apparatus arranged to calculate the location of a mobile terminal in a communications network, the location module comprising:
means for estimating a location of the mobile terminal; and
means for calculating a region around the estimated location in which the mobile terminal could be located.

30. A method for locating a mobile terminal in a communications network, the method comprising the steps of:
applying one of a plurality of available methods to estimate a location of the mobile terminal; and
applying one of a plurality of available methods to calculate a region around the estimated location in which the mobile terminal could be located.
